(19) United States
(12) Patent Application Publication
(10) Pub. No.: US 2010/0244392 A1
(43) Pub. Date: Sep. 30, 2010

(54) Holding device for fastening element

(76) Inventors: Michael Ruhstaller, Siebnen (CH); Marco Zurkirchen, Bubikon (CH); Markus Kieber, Schaanwald (LI)

Correspondence Address: ABELMAN, FRAYNE & SCHWAB, 666 THIRD AVENUE, 10TH FLOOR, NEW YORK, NY, 10017, US

(21) Appl. No.: 12/657,275

(22) Filed: Jan. 15, 2010

(30) Foreign Application Priority Data
Jan. 16, 2009 (DE) 10 2009 000 264.2

(51) Int. Cl. B23B 5/22

(52) U.S. Cl. 279/145

(57) ABSTRACT

A holding device (10) for a fastening element (51) includes at least two gripping elements (20a, 20b) each having a clamping jaw (21, 22) provided thereon, with the clamping jaws (21, 22) engaging, in their support position (19), a shaft (52) of the fastening element (51), and with at least one clamping jaw (21, 22) having, at its free end (27) adjacent to another clamping jaw (21, 22), a recess (23, 24) for the fastening element (51) and a defining an axis (A), and a pivot element (25) for pivotally supporting at least of the clamping jaws (21, 22) on a respective griping element (20a, 20b) and having a pivot axis (S) extending substantially axial to the axis (A) defined by the recess (23, 24) of the at least one clamping jaw.

### BACKGROUND OF THE INVENTION

1. Field of the Invention

The present invention relates to a holding device for a fastening element mountable on a power drive-in tool and having at least two gripping elements each having a clamping jaw provided thereon, with the clamping jaws engaging, in their support position, a shaft of the fastening element, and with at least one clamping jaw having, at its free end adjacent to another clamping jaw, a recess for the fastening element and defining an axis.

2. Description of the Prior Art

Holding devices of the type described above which are mountable on a power drive-in tools (such as, e.g., screw-driving tools) serve for holding a fastening element before start of a drive-in process and for guiding the fastening element during the drive-in process in order to prevent damage of the surface of the workpiece, into which the fastening element is driven in, by a side-slipping fastening element.

European Publication EP 1452 276 A1 discloses a holding device for a fastening element and which is mountable on a screw-driving tool. The holding device holds the fastening element that is driven-in by a tool bit insertable therein. The holding device has two gripping elements which engage, in a support position, a shaft of a fastening element and are displaced in a release position, in which they are spaced from the shaft, upon application of a force to the gripping elements. Each of the gripping elements is provided with a clamping jaw, with at least one of the jaws having, at its free end adjacent to the other jaw, a recess that defines an axis. The gripping elements have at least one contact region that forms, at least in the support position, a frontmost stop of the holding device in a drive-in direction of the screw-driving tool.

An object of the present invention is to improve feeding and a subsequent guidance of the fastening element in the holding device for a fastening element of a type described above.

### SUMMARY OF THE INVENTION

This and other objects of the present invention, which will become apparent hereinafter, are achieved according to the invention, by providing pivot means for pivotally supporting the at least one clamping jaw on a respective gripping element and having a pivot axis extending substantially parallel to the axis defined by the recess of the at least one clamping jaw. Under “substantially parallel” is understood a condition in which the pivot axis extends to the axis, which is defined by the recess of the at least one clamping jaw, with a slight inclination at an angle up to 15°. The pivot means provides for pivotal movement of the clamping jaw of at least one gripping element away from the other clamping jaw in the feeding direction of the fastening element so that the fastening element can be easily received in the recess of the other clamping jaw. After the fastening element has been received in the recess of the other jaw which remains stationary, the pivotable clamping jaw can pivot again into the support position in which the fastening element is held and guided.

Advantageously, a spring biases the at least one clamping jaw in a support direction. Thereby, the at least one clamping jaw in each orientation with respect to the gravity force, is automatically pivoted back in its support position.

Advantageously, the recess of the at least one clamping jaw opens on a side thereof located opposite the feeding direction of the fastening element.

An easy pivotal movement of the at least one clamping jaw by the fed fastening element can be achieved when the at least one pivotable clamping jaw has, in a region of the recess, an entry bevel for the fastening element.

It is advantageous when the other clamping jaw has a support surface for the pivotable at least one clamping jaw, and the at least one clamping jaw has a projection with which is supported on the support surface of the other clamping jaw in the support position of the clamping jaws. Thereby, the position of the at least one pivotable clamping jaw in the support position is clearly defined.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a holding device for fastening elements according to the present invention in a mounted, on a drive-in power tool, condition;

FIG. 2 a partial cross-sectional view of the holding device along line II-II in FIG. 1;

FIG. 3 a partial cross-sectional view of the holding device in accordance with FIG. 5 before feeding of a fastening element;

FIG. 4 a partial cross-sectional view of the holding device in accordance with FIG. 5 during feeding of a fastening element;

FIG. 5 a partial cross-sectional view of the holding device in accordance with FIG. 5 with an already set-in fastening element; and

FIG. 6 a partial cross-sectional view of the holding device in accordance with FIG. 2 during a drive-in process.

### DETAILED DESCRIPTION OF THE PREFERRED EMBODIMENT

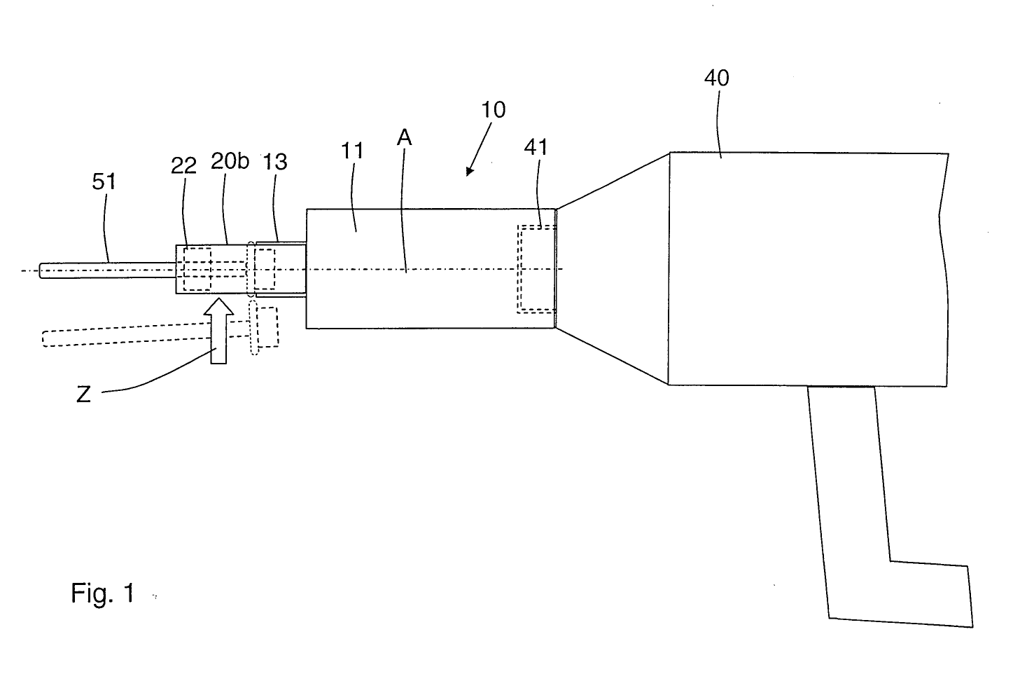

A holding device 10 according to the present invention, which is shown in FIGS. 1-6, has a base body 11 with which it is mounted, as shown in FIG. 1, on a flange 41 of a power drive-in tool 40 shown only schematically in FIG. 1. A power drive-in tool shown in FIG. 1 is formed as an electrically driven screw-driving tool. The holding device 10 serves for retaining and guiding a manually insertable fastening element 51. Alternatively, however, the holding device 10 can cooperate with a magazine for fastening elements from which a fastening element is fed to the holding device.

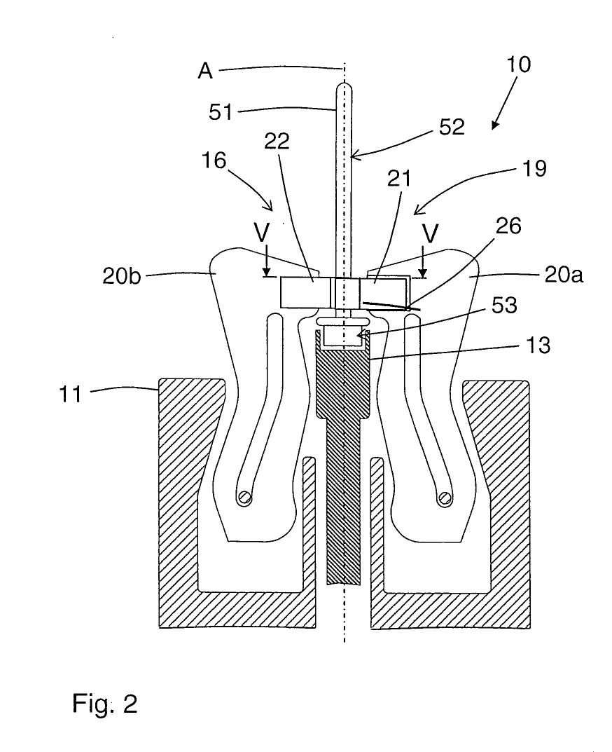

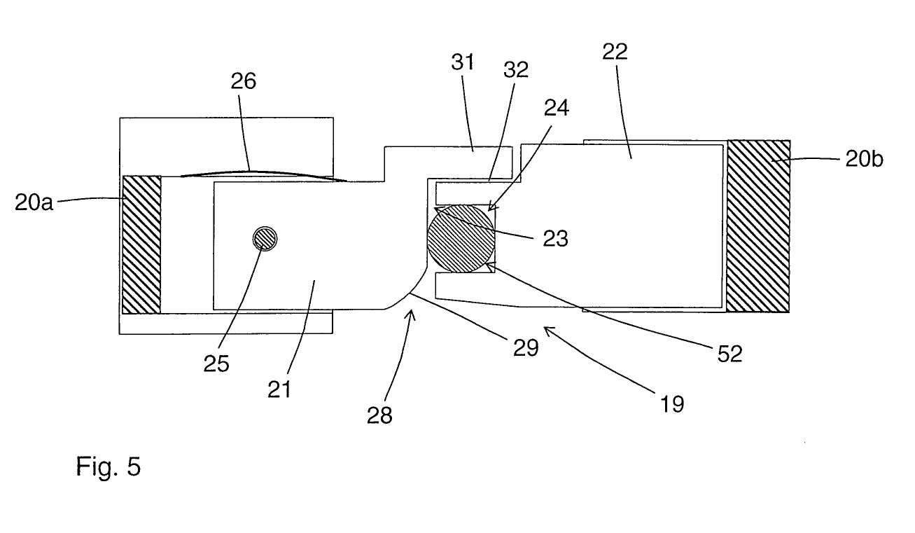

A drive-in bit 13, which is formed as a screw-driving bit and which can be rotated by the power drive-in tool 40, is advanced into the holding device 10. The holding device 10 further has two gripping elements 20a, 20b which are formed as gripping arms displaceable over the base body 11. On each of the gripping elements 20a, 20b, there is provided, respectively, on their adjacent sides, clamping jaws 21, 22. Both clamping jaws 21, 22 have, respectively, at their free ends 22, recesses 23, 24. In their support position 19 shown in FIGS. 2 and 5, the gripping elements 20a, 20b form a receiving and guide space for a shaft 52 of the fastening element 51. The recesses 23, 24 define an axis A that corresponds to a tool axis of the drive-in bit 13 and a drive-in axis of the fastening element 51.

The first clamping jaw 21 is pivoted by a pivot axle 25 the pivot axis of which extends parallel to the axis A and on which the first gripping element 21 is supported. The second clamping jaw 22 is fixedly secured on the second gripping element 20b. A spring 26 biases the first pivotable clamping jaw 21 in direction of the support position 19. On the second clamping jaw 22, there is provided a support surface 32 for the pivotable first clamping jaw 21. The first clamping jaw 21 has a projection 31 with which it is supported on the support surface 32 in the support position 19.

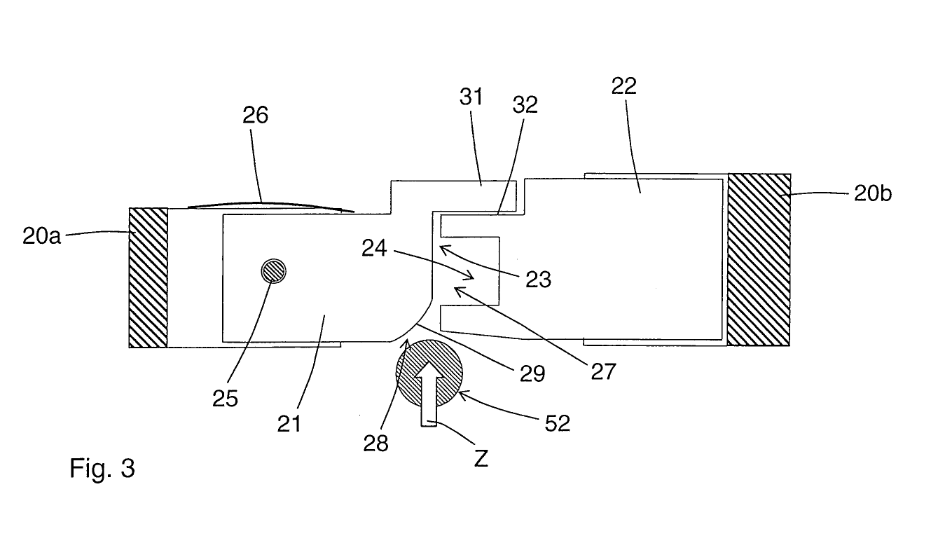

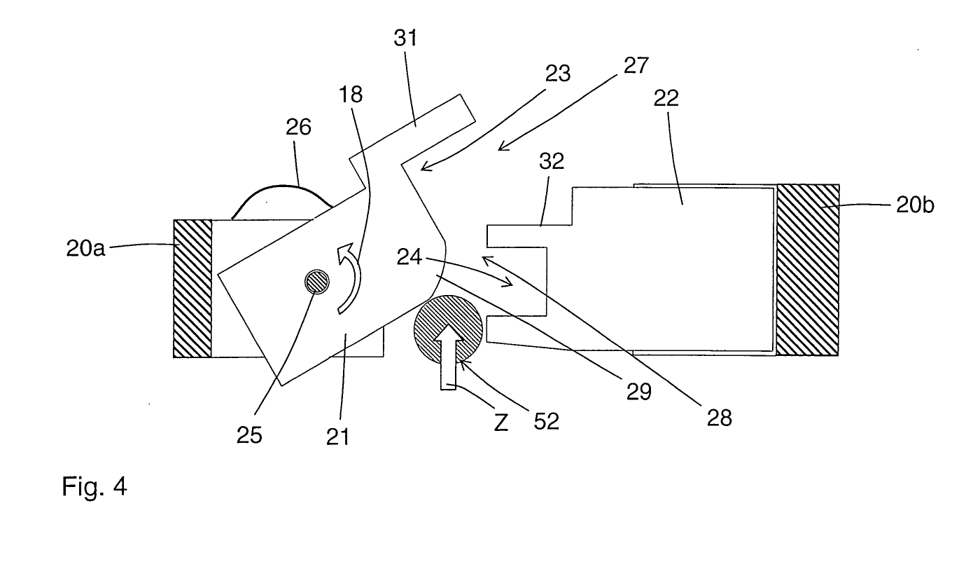

In FIG. 3, the fastening element 51 is manually inserted with its shaft 52 in the holding device 10 in the feeding direction Z. As shown in FIG. 4, the shaft 52 of the fastening element 51, which is pushed against an entry bevel 29 in a region of an open side 28 of the recess 23 of the first clamping jaw 21, pivots the first clamping jaw 21 in direction of the arrow 18. As soon as the shaft 52 of the fastening element 51 occupies its place in the recess 24 at the free end of the second clamping jaw 22, the spring 26 biases the first clamping jaw 21 in its support position 19 shown in FIGS. 1 and 5.

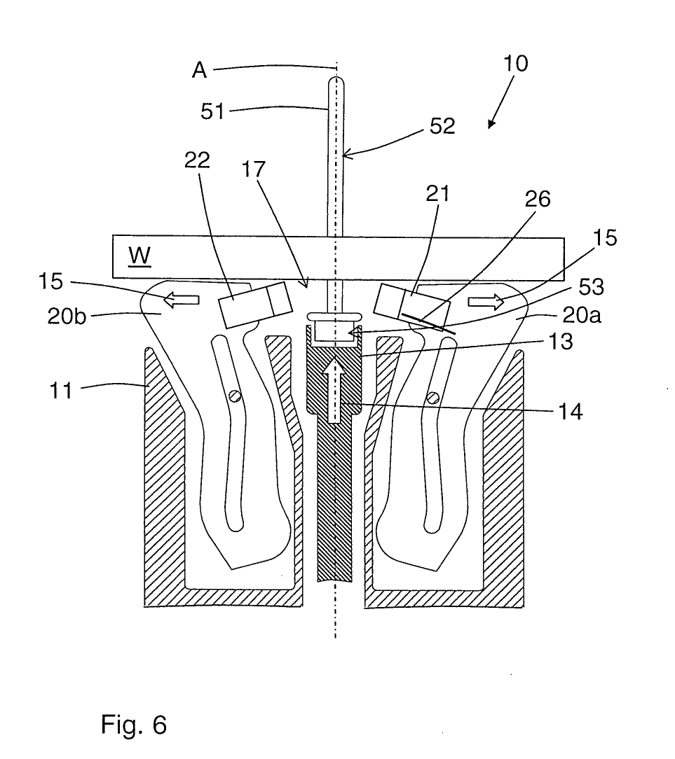

When the drive in power drive-in tool 40 is pressed, with the arranged thereon, holding element 10, against a workpiece W, as shown in FIG. 6, the base body 11 is displaced relative to the gripping elements 20a, 20b in direction of arrow 14. During this movement, the gripping elements 20a, 20b are displaced away from each as shown with arrows 15. As a result, the gripping elements 20a, 20b pivot from their closed position 16 (FIG. 2) in an open position 17 in which the clamping jaws 21, 22 do not guide the fastening element 51, releasing it. In this position, the clamping jaws 21, 22 are spaced from the axis A by a greater distance than in their closed position 17. The movement of the clamping jaws 21, 22 away from each other takes place before the fastening element 51 is completely screwed in the workpiece W.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A holding device (10) for a fastening element (51) mountable on a power drive-in tool (40), the holding device (10) comprising at least two gripping elements (20a, 20b) each having a clamping jaw (21, 22) provided thereon, the clamping jaws (21, 22) engaging, in a support position (19) thereof, a shaft (52) of the fastening element (51), and at least one clamping jaw (21, 22) having, at a free end (27) thereof adjacent to another clamping jaw (21, 22), a recess (23, 24) for receiving the fastening element (51), the recess defining an axis (A); and pivot means (25) for pivotally supporting at least one of the at least one clamping jaw and the another clamping jaw on a respective griping element (20a, 20b) and having a pivot axis (S) extending substantially parallel to the axis (A) defined by the recess (23, 24) of the at least one clamping jaw.

2. A holding device according to claim 1, further comprising a spring (26) for biasing the at least one of the at least one clamping jaw and the another clamping jaw (21, 22) in a direction of the support position (19).

3. A holding device according to claim 1, wherein the recess (23) of the at least one clamping jaw (21) opens on a side (28) thereof located opposite the feeding direction (Z) of the fastening element (51).

4. A holding device according to claim 3, wherein the at least one clamping jaw (21, 22) has, in a region of an open side (28) of the recess (23), an entry bevel (29) for the fastening element (51).

5. A holding device according to claim 1, wherein the another clamping jaw (21, 22) has a support surface (32) for the at least one clamping jaw (21, 22), and the at least one clamping jaw (21, 22) has a projection (31) with which it is supported on the support surface (32) in the support position (19) of the clamping jaws (21, 22).

6. A holding device according to claim 1, wherein the at least one clamping jaw (21, 22) has a support surface for the another clamping jaw (21, 22), and the another clamping jaw (21, 22) has a projection with which it is supported on the support surface in the support position (19) of the clamping jaws (21, 22).

7. A holding device according to claim 1, wherein the another clamping jaw (21, 22) has, at a free end thereof adjacent to the at least one clamping jaw, a recess (23, 24) for receiving the fastening element.
